(19) United States
(12) Patent Application Publication
(10) Pub. No.: US 2010/0013196 A1
(43) Pub. Date: Jan. 21, 2010

(54) Inflatable and Foldable Stroller

(76) Inventors: Amnon Katzir, Ramat Gan (IL); Uzi Ezra Havosha, Tel Aviv (IL); Edith Katzir, Ramat Gan (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/173,833

(22) Filed: Jul. 16, 2008

(51) Int. Cl. B62B 3/00

(52) U.S. Cl. 280/647

(57) ABSTRACT

A stroller that is inflatable/deflatable and foldable to aid transportation. Wheels to aid dragging on the ground like a suitcase on wheels. Optionally, a power source and air compressor to aid inflation.

### FIELD OF THE INVENTION

This invention is in the field of strollers and more particularly a stroller that is inflatable and foldable with wheels and a handle convenient handling.

### BACKGROUND OF THE INVENTION

There are many kinds of children's strollers with many designs for folding and erecting to ease the burden on the adult user who benefits from a light construction with ease of collapsing and erecting.

This invention reveals yet another kind of stroller to achieve these aims.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

This invention reveals a stroller that has a case that inflates with at least two sections in such a way that the two sections form at least part of the framework of the stroller. To the body of the case is attached at least one inflatable seat. To a first section of the case is attached at least one wheel and to a second section is attached at least two wheels whereby the case when open may be wheeled along by means of pushing.

In addition, there could be attached, at a position close to the folding axis of the sections of the case, two wheels that both add stability to the opened out case and act as traveling wheels when the case is closed.

There could also be a source of electricity and a means of producing air pressure attached to the case, as air pump, for blowing air into the inflatable case and inflatable seat. Alternatively, there might be a connection to external source of electricity and a means of producing air pressure as to an air pump in petrol station, or to the a cig lighter in a car. Another option is a manually operated air pump that could be attached to the case.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic depiction of the inflatable stroller ready for use.

FIG. 2 is a schematic depiction of the inflatable stroller being folded in its case.

FIG. 3 is a schematic depiction of the inflatable stroller folded in its case.

FIG. 4 is an enlarged depiction of a method of joining the inflatable seat to the case.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

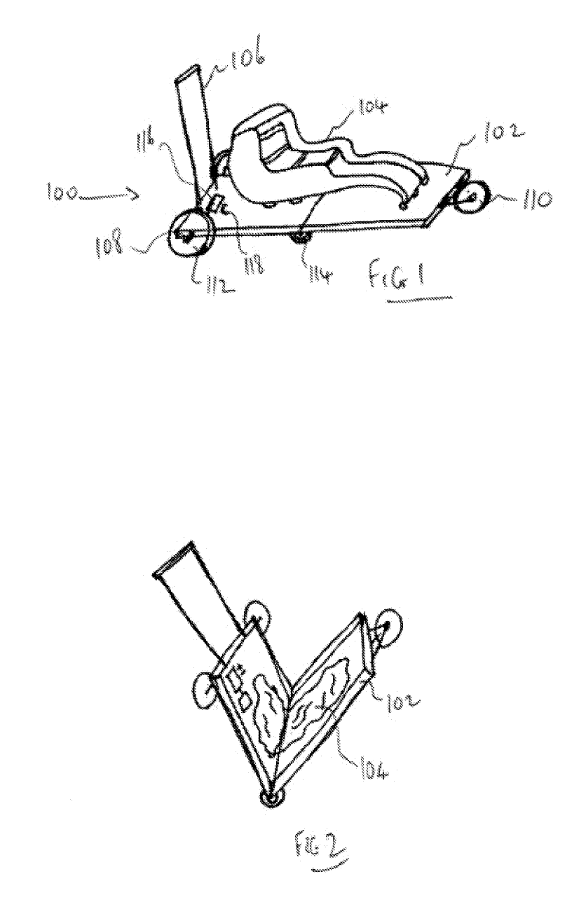

FIG. 1 shows the inflatable case 102 of the inflatable stroller 100. The inflatable seat 104 is attached to the base of the case 102. A pushing handle 106 is attached to the back wheel chassis 108. One front wheel 110 is attached to the front of the frame of the case 102. Two back wheels 112 are attached to chassis 108 and the chassis 108 is attached to the frame of the case 102.

For extra stability the case 102 is supported by wheels 114 situated under the case 102 approximately half way along the length of case 102. When the seat 104 is deflated and the case 102 is folded, the wheels 114 act as traveling wheels for ease of transport of the closed case 102. Optionally, there can be attached to the case, a battery 116 or other source of electricity and an air pump 118 to facilitate the inflation process. Alternatively or in addition there could be a manually operated air pump for this purpose.

FIG. 2 shows the case 102 being folded after the air in the case 102 and in the seat 104 has been removed.

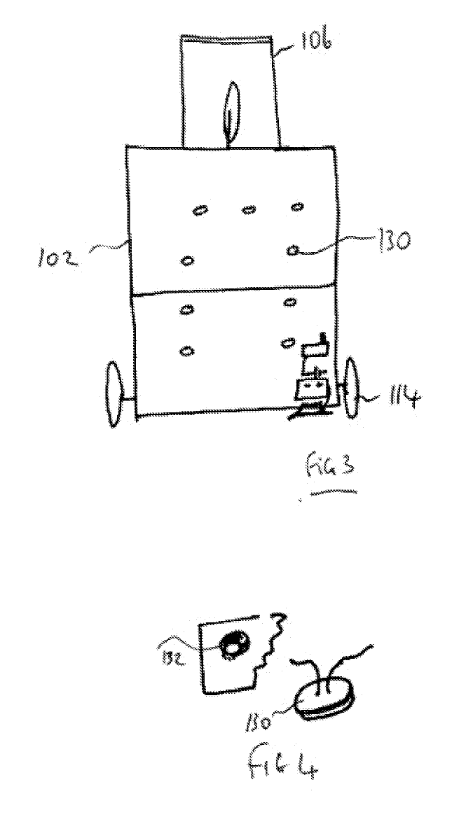

FIG. 3 shows the case 102 fully folded. The wheels 114 now act as traveling wheels to ease transportation. The handle 106 is used to pull the case 102.

The buttons 130 are on the outer facing wall or section of the folded case 102 or on the underside of the opened case 102 and are attached to the inflatable seat FIG. 1 104. The seat FIG. 1 104 is on one side of the case 102 surface and the attachment of the seat FIG. 1 104 by buttons 130 from the other side of the case 102 ensures a secure attachment.

FIG. 4 shows an enlarged view of the button 130 that is attached to and forms part of the seat FIG. 1 104 and the hole 132 in the inflated wall of the case 102.

The present invention is not intended to be limited to the embodiments described above, but to encompass any and all embodiments within the scope of the following claims.

What is claimed:

1. An inflatable and foldable stroller comprising,
a. a case that inflates divided to at least two sections in such a way that said two sections form at least part of the framework of said stroller and can be folded,
b. at least one inflatable seat attached to the body of said case,
c. at least one wheel attached to said first section of said case, and
d. at least two wheels attached to said second section of said case, whereby said case when open may be wheeled along by means of pushing.

2. An inflatable and foldable stroller as claimed in claim 1 further comprising at least one of the following
a. a source of electricity and a means of producing air pressure as air pump attached to said case for blowing air into said inflatable case and said inflatable seat.
b. a manually operated air pump attached to said case.
c. a connection to external source of electricity and a means of producing air pressure.

3. An inflatable and foldable stroller as claimed in claim 1 further comprising two wheels attached at a position close to the folding axis of said sections of said case, wherein said two wheels add stability to the opened out said case and act as traveling wheels when said case is closed.

4. An inflatable and foldable stroller comprising,
a. a case that inflates with at least two sections in such a way that said two sections form at least part of the framework of the said stroller,
b. at least one inflatable seat attached to the body of said case,
c. at least one wheel attached to said first section,
d. at least two wheels attached to said second section,
e. two wheels attached at a position close to the folding axis of said sections of said case, said two wheels add stability to the opened out said case and act as traveling wheels when said case is closed.

5. An inflatable and foldable stroller as claimed in claim 4 further comprising a source of electricity and a means of producing air pressure, attached to the said case, for blowing air into the said inflatable case and inflatable seat.

6. An inflatable and foldable stroller as claimed in claim 5 wherein said means of producing air pressure is an air pump.

7. An inflatable and foldable stroller as claimed in claim 4 further comprising a manually operated air pump attached to the said case.

8. An inflatable and foldable stroller as claimed in claim 4 further comprising connection to external source of electricity and a means of producing air pressure for blowing air into said inflatable case and inflatable seat.
